(19) United States
(12) Patent Application Publication
(10) Pub. No.: US 2014/0334882 A1
(43) Pub. Date: Nov. 13, 2014

(54) Hand tool that digs a shallow trench and places drip irrigation tubing

(71) Applicants: Noah Webster Gale, Santa Cruz, CA (US); Dale Lee Walter, San Jose, CA (US)

(72) Inventors: Noah Webster Gale, Santa Cruz, CA (US); Dale Lee Walter, San Jose, CA (US)

(21) Appl. No.: 13/891,171

(22) Filed: May 9, 2013

(51) Int. Cl. E02F 5/10; A01C 7/02; F16L 1/032

(52) U.S. Cl. CPC E02F 5/10; F16L 1/032; A01C 7/02
USPC 405/183; 172/381; 111/154

(57) ABSTRACT

A hand tool that digs a shallow trench and places drip irrigation tubing, cable, or electrical wire is disclosed. The invention simplifies the process of laying drip irrigation tubing, cable, or wire requires less labor, fewer materials, and is not as costly. The tool has a rubber handle, a steel tube shaft, a hard metal claw for slicing through dirt, and polyethylene flexible tubing for guiding irrigation hose or electrical cable into the dirt. It also has a small cylinder and set screw for holding the tubing, and easy replacement when it wears out.

Priority claimed from provisional application U.S. 61/645,501, filed May 10, 2012

### BACKGROUND OF THE INVENTION

This invention relates to garden tools

Drip irrigation tubing needs to be placed underground. This process is labor intensive and needs simplification.

The process of laying drip irrigation by hand/labor is costly. Presently, the process is accomplished by hand digging a trench, pulling the tubing, stapling it to the bottom of the trench then shoveling dirt to cover. There is a need for a process of laying drip irrigation tubing which requires less labor, fewer materials, and is not as costly.

### FIGURE SPECIFICATION

FIG. 1 shows worker using tool to place drip tubing below ground.

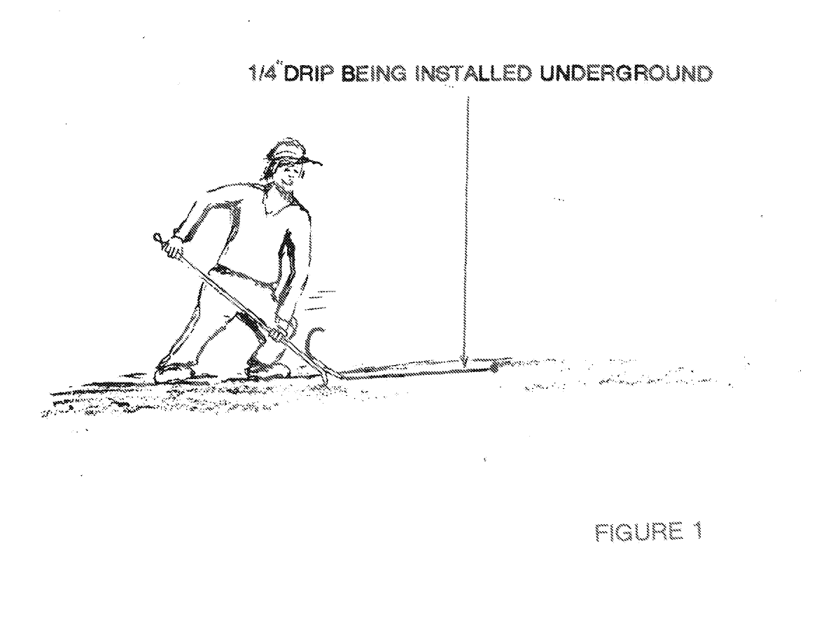

FIG. 2 shows top view, side view and bottom view of tool.

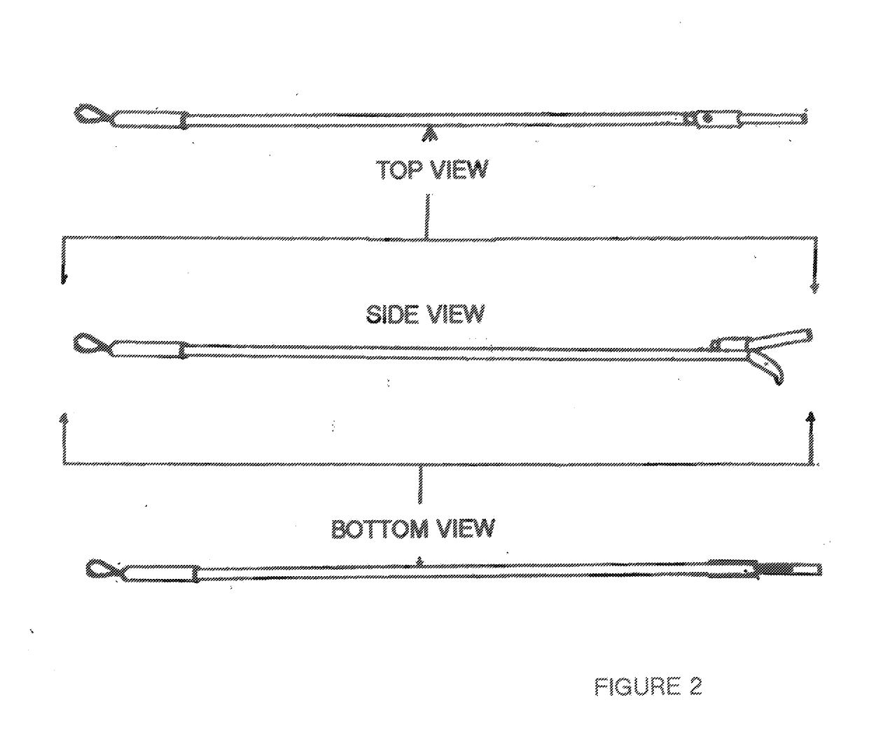

FIG. 3 shows side view with construction specifications.

### DETAILED DESCRIPTION OF THE INVENTION

This tool digs a shallow trench while simultaneously pressing the drip tubing into the bottom of the trench and covering the tube with dirt.

The invention simplifies the process of laying drip irrigation tubing, requires less labor, fewer materials, and is not as costly.

### The Version of the Invention Discussed Here Includes

1. 3 foot long piece of ½″ tubing

2. 5 inch long, 3/16″ thick steel claw

3. 6″ piece of ½″ low density polyethylene flexible tubing

4. Rubber handle

5. ½″ steel coupler with set screw

### Relationship Between the Components

#1 and #4 are used to push #2 1-2″ into the dirt while dragging the tool horizontally, thus digging a shallow trench; #3 follows #2 in the base of the trench, pressing ⅜″ or less drip tube, cable, low voltage wire down into the trench while covering the tube, cable or wire with dirt. #5 holds #3.

### How the Invention Works

Pull the desired length of tubing (drip, cable, electrical) through the flexible sleeve. Using the handle, push the claw into the dirt. Drag the tool horizontally along in the direction tube must be laid. The tubing will be laid into the shallow trench as the tool is drug through the dirt. The dirt will cover the tubing after it has been laid. At the end point, pull the tool straight up out of the ground. This tool can be used for any type of flexible tubing, pipe, or electrical cable. The flexible tubing is the key to keeping the correct tension on the smaller tubing, cable, or electrical wire so as to keep it at the base of the trench while dirt is brought back into trench setting it in place.

### How to Make the Invention

The claw is inserted 2″ into the end of the ½″ steel tube. The tube is hammered around claw and welded. The ½″ coupler is welded to the ½″ tube; ½″ steel tube end is inserted and affixed into rubber handle. Insert ½″ low density polyethylene flexible tubing into the ½″ coupler.

If the sleeve fits snugly, then no special fastener is needed. The sleeve may be fastened to the coupler by drilling a small hole and inserting a set screw. Other fasteners are possible.

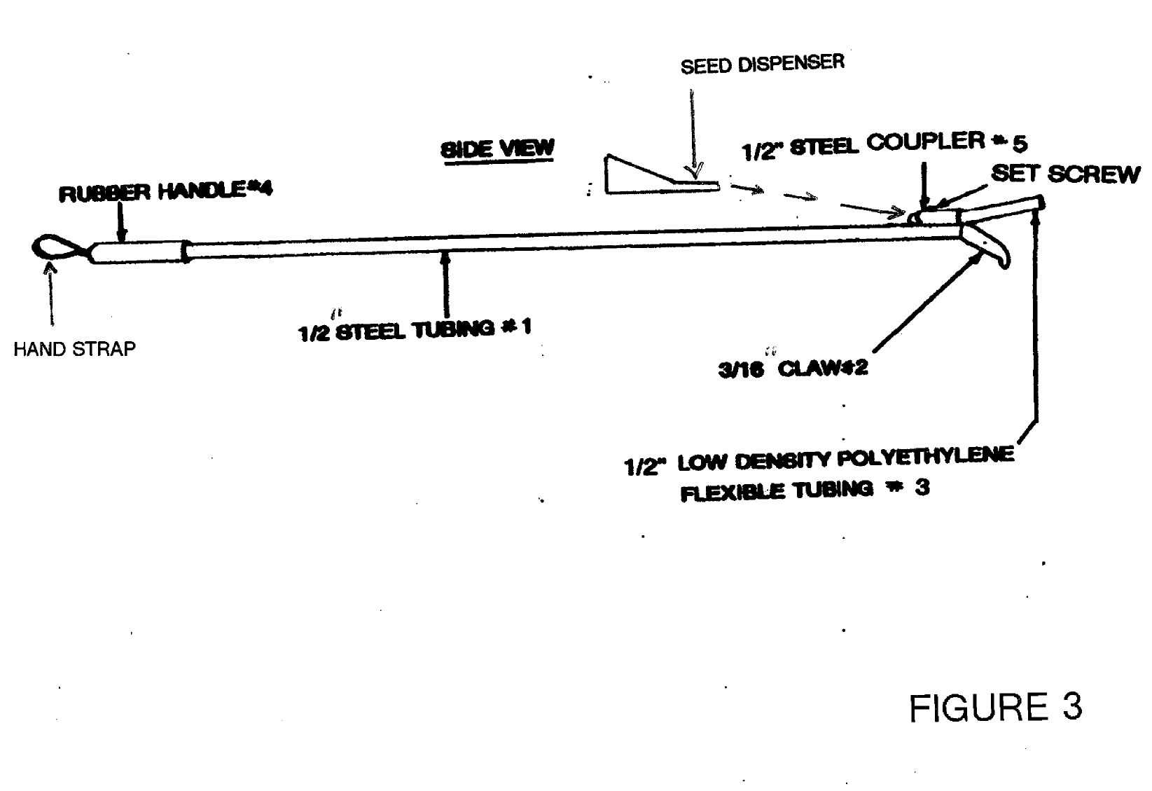

The rubber handle is not necessary, but it does make for more comfortable usage. The handle may also have a hand strap as shown in FIG. 3, for ease of use or hanging in the shop.

### How to Use the Invention

Instead of hand digging a trench, pulling and stapling tubing, then shoveling dirt over tubing, this hand tool will solve the same problem. Pull the desired length of tubing (drip, cable, electrical) through the flexible sleeve. Using the handle, push the claw into the dirt. Drag the tool horizontally along the in the direction tube must be laid. The tubing will be laid into the shallow trench as the tool is drug through the dirt. The dirt will cover the tubing after it has been laid. At the end point, pull the tool straight up out of the ground. This tool can be used for any type of flexible tubing, pipe, or electrical cable. The ½″ flexible tubing is replaceable as needed.

Additionally: The tool could be used to dig, spread and cover seeds in a garden or field.

The prototype was used to run about 400 drip lines to plants in a couple of hours. The prototype was held together with hose clamps, the new tool will be welded instead of using hose clamps to hold it together.

We claim:

1. A digging tool, comprising:
a steel tube, approximately 3 feet long and a half inch in diameter;
a hard metal claw, approximately 5 inches long and 3/16 inches thick, with one end inserted into said tube and welded, and other end having a dull pointed hooked shape suitable for digging; and
a cylindrical steel coupler, approximately half inch diameter, welded parallel to the outside of said tube near said claw, so that said claw points away from said coupler.

2. The digging tool of claim 1, further comprising a replaceable flexible plastic sleeve, approximately 6 inches long, with one end fitting snugly into said coupler, and other end approximately even with said hooked shape.

3. The digging tool of claim 2, further comprising means for fastening said sleeve to said coupler.

4. The digging tool of claim 2, further comprising a screw hole in the outer part of said coupler, and a set screw in said screw hole, holding said sleeve firmly in place.

5. The digging tool of claim 2, further comprising a seed dispenser attached to said sleeve at said coupler.

6. The digging tool of claim 2, further comprising a rubber handle attached to said tube at the opposite end from said claw.

7. A method for laying underground tubing, comprising the steps:
inserting a plastic sleeve in a cylindrical coupler near a hard metal claw at the end of a rod-shaped tool;
threading some flexible tubing through said sleeve;
gripping said tool to dig a narrow trench in dirt with said claw;
feeding said tubing through said sleeve into said trench while digging said trench; and
allowing said dirt to cover said tubing as said tool is pulled.
